(19) United States
(12) Patent Application Publication
(10) Pub. No.: US 2021/0374314 A1
(43) Pub. Date: Dec. 2, 2021

(54) Engineering Change Order Scenario Compression by Applying Hybrid of Live and Static Timing Views

(71) Applicant: Synopsys, Inc., Mountain View, CA (US)

(72) Inventors: Nahmsuk Oh, Palo Alto, CA (US); Guangming Zeng, Sunnyvale, CA (US)

(21) Appl. No.: 17/332,861

(22) Filed: May 27, 2021

Related U.S. Application Data
(60) Provisional application No. 63/031,404, filed on May 28, 2020.

(51) Int. Cl. G06F 30/3315

(52) U.S. Cl. CPC G06F 30/3315; G06F 2119/08

(57) ABSTRACT

A method and apparatus for preforming engineering change order scenario compression by applying a hybrid of live and static timing views to an integrated circuit design. A plurality of operational scenarios are identified with at least one operational condition. The operational status for a plurality of operational features is determined under conditions associated with the identified scenarios. The operational scenarios are divided into live and static views. Margins are then associated with the operational features within at least one scenario of a static view. Information is transferred from at least one scenario of a static view to a merged live view through the margin.

### CROSS-REFERENCE TO RELATED APPLICATIONS—CLAIM OF PRIORITY

The present application claims priority to U.S. Provisional Application No. 63/031,404, filed May 28, 2020, entitled “ECO Scenario Compression by Applying Hybrid of Live and Static Timing Views”, which is herein incorporated by reference in its entirety.

### TECHNICAL FIELD

The present disclosure relates to design of integrated circuits and more particularly to validating timing of circuits of an integrated circuit design.

### BACKGROUND

An increasing number of integrated circuits (IC) are being fabricated using a technology node of less than 7 nm. In addition, design complexity is increasing. These two factors are combining to cause an increase in the number of process corners (e.g., temperature and voltage corners). That is, in semiconductor manufacturing, process variations and differences in operational voltages and temperatures cause variation in the performance of the circuits fabricated on an IC chip. In particular, the timing of signals that flow through the signal paths of the IC design can vary due to variations in manufacturing parameters during the fabrication of an IC design on a semiconductor wafer and due to variation in the operating temperature and operating voltage. Such variations require testing over the range of these parameters to ensure proper operation across the full range of operating conditions over which the IC circuit may be operated. A circuit operating at these process corners may run slower or faster and so may not function properly. The increasing number of process corners is resulting in an increase in the number of required Static Timing Analysis (STA) scenarios needed to ensure proper operation of the device. Each “scenario” models the timing of the circuits of the IC design for a particular combination of process variables and operational variables (i.e., variations in the manufacturing processes and variations in voltage and temperature). The number of required STA scenarios may be in the hundreds, often exceeding 500 scenarios. The requirement to determine the timing of each path through the IC design for such a large number of STA scenarios in order to attain “power sign-off” (i.e., confirm and report proper operation) presents a significant challenge during the “Engineering Change of Order” (ECO) stage of chip design. This challenge is due, at least in part, to the need for a large amount of hardware resources (processing resources and memory) and the resulting longer ECO cycle and runtimes. Additional challenges come from the need to work on hundreds of STA scenarios and fix violations for all of the STA scenarios simultaneously. This can take months, often taking as much as 50% of the entire time required to complete the chip design cycle.

One common method to reduce the amount of hardware resources required is to pick a limited number of dominant scenarios and fix violations for only those. However, often times, this creates new timing violations in non-dominant scenarios that can result in a “ping-pong” effect. That is, new violations are created in scenarios that were not selected in the course of fixing violations that existed in the originally selected scenarios

### SUMMARY

A method and apparatus is disclosed that reduces the amount hardware resources required to perform Static Timing Analysis (STA). The number of scenarios needed to ensure proper operation of the device is reduced and concurrently the problem of creating new timing violations as current violations are resolved is addressed. In particular, the disclosed method and apparatus compresses STA scenarios using a hybrid of “live” and “static” timing views. Information necessary to fix timing violation is transferred from the static timing views to the live timing views.

A classifier divides timing scenarios into live and static timing views Timing in the live views is updated on the fly during the “Engineering Change Orders” ECO stage as changes are made to the design to “fix” timing violations. In contrast, the timing associated with the signal paths in the scenarios of the static timing views are not updated as fixes are made. Instead, timing for the signal paths determined for scenarios of the static timing views are captured once at the beginning of the ECO process and “transferred” to the scenarios of the live views. A “margin” is calculated and used to take into account the timing associated with the scenarios in the static views.

The disclosed method and apparatus enables a reduction from hundreds of scenarios to a range of approximately ten to twenty scenarios that need to be actively managed. The result is a much faster ECO cycle requiring much fewer hardware resources. Often, the amount of hardware resource required is less than 1/10^{th} the amount of hardware resource required using conventional methods.

### BRIEF DESCRIPTION OF THE DRAWINGS

The disclosure will be understood more fully from the detailed description given below and from the accompanying figures of embodiments of the disclosure. The figures are used to provide knowledge and understanding of embodiments of the disclosure and do not limit the scope of the disclosure to these specific embodiments. Furthermore, the figures are not necessarily drawn to scale.

FIG. 1 is a simplified diagram illustrating some aspects of the disclosure.

FIG. 2 illustrates a simplified example of the data associated with one STA scenario.

FIG. 3 is a simplified illustration of three STA scenarios (Scenario A, Scenario B and Scenario C) and how they might be “merged” under ideal conditions.

FIG. 4 is a simplified illustration of the use of live view and static views.

FIG. 5 is an illustration of how the timing violation for a path in a Scenario in the static view is transferred to the merged live views.

FIG. 6 illustrates an example set of processes used during the design, verification, and fabrication of an article of manufacture, such as an IC, to transform and verify design data and instructions that represent the IC.

FIG. 7 depicts an abstract diagram of an example emulation environment.

FIG. 8 illustrates an example machine of a computer system in which a set of instructions may be executed to cause the machine to perform one or more processes.

### DETAILED DESCRIPTION

Aspects of the present disclosure relate to Engineering Change Order (ECO) scenario compression by applying a hybrid of live and static views and provides a method and apparatus that can reduce the amount of hardware required to handle the number of required Static Timing Analysis (STA) scenarios needed to ensure proper operation of the device and concurrently to avoid the ping pong effect noted above.

In accordance with the disclosed method, a plurality of operational scenarios are identified. Each operational scenario is associated with at least one condition. The operational status for a plurality of operational features is determined under the conditions associated with one or more of the plurality of scenarios. The operational scenarios are divided into live and static views. Differences between the operational features of the static and live views are used to determine margins associated with operational features within at least one scenario of a static view. The information from at least one scenario of a static view is transferred to a merged live view through the margin.

Advantages of the present disclosure include, but are not limited to reducing the amount of hardware required to handle the number of required STA scenarios needed to ensure proper operation of the device and concurrently avoiding the ping pong effect noted above.

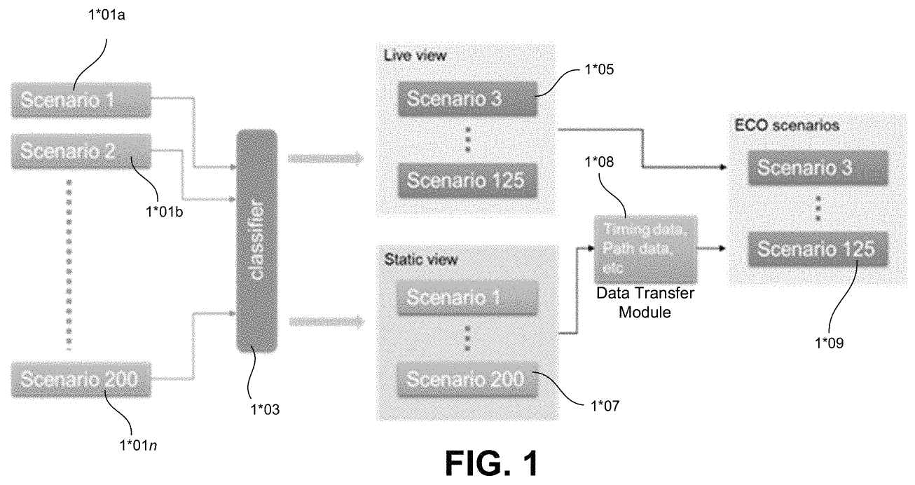

FIG. 1 is a simplified diagram illustrating some aspects of the disclosure as applied to a particular example. In the diagram, two hundred different scenarios, such as STA scenarios 101, are presented to a classifier 103. It should be noted that throughout this disclosure, features illustrated in the figures that are referenced by a common numeric portion followed by a unique alphabetic portion may be referenced collectively by the common numeric portion. For example, the scenario 101a and 101b may be referenced collectively as “scenario 101”. In addition, the “n” following 101 indicates a variable and not the 14^{th} scenario (n being the fourteenth letter in the alphabet). Accordingly, there may be any number of scenarios (in one example, there are two hundred such scenarios).

In one such example in which two hundred timing scenarios are required for timing closure, each STA scenario represents an operational feature, such as the timing for a plurality of unique paths through the integrated circuit (IC) design, under a unique combination of conditions, such as operational and process conditions applied to the IC.

For example, one particular STA scenario 101a may represent the timing through each of a plurality of paths of the IC design with the IC operating at a voltage of 5.9 volts, a temperature of 140 degrees Fahrenheit and with a particular set of assumed manufacturing process conditions. Those skilled in the art will be familiar with the manner in which the STA is performed for particular STA scenarios. A second scenario may represent the timing through each of the same paths of the IC design with the IC operating at a voltage of 5.9 volts, a temperature of 140 degrees Fahrenheit, but with a different set of assumed manufacturing process conditions. Each of the 200 scenarios 101 will have a different set of assumed conditions.

Each of the 200 scenarios 101 is applied to the classifier 103. The classifier 103 determines whether to classify the scenario 101 as a live view scenario 105, or a static view scenario 107. Differences between the timing on the paths of the scenarios of static and live views are used to determine margins associated with timing within at least one scenario of a static view. The margins are used to “transfer” timing information from the static views 107 to the live view scenarios 105 by a data transfer module 108 so that timing violations and other ECO data across all scenarios are contained in live views to form ECO scenario views 109.

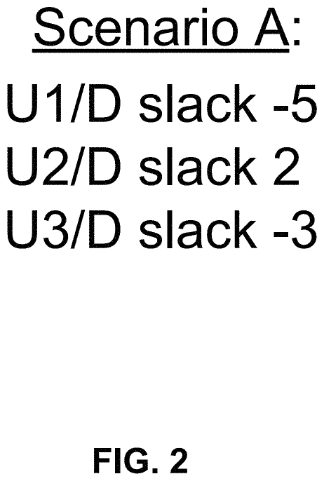

FIG. 2 illustrates a simplified example of the data associated with one STA scenario 101. In this example, the IC design has just three paths to be analyzed for the sake of simplicity in the example. However, it should be noted that typically an IC design has a very large number of cells, each cell having only one path or several paths. The STA Scenario A includes data for each cell of the design. In the example, a first path flows through a first cell “U1” and terminates at a “D” pin in the cell. Accordingly, the path is identified as the “U1/D” path. The slack for this path is −5. “Slack” is the difference between the time it takes a signal to propagate from the beginning of the path to the termination point (i.e., the D pin in this case) and the propagation time required for proper operation. Typically, a negative slack indicates that the signal propagates more slowly than is permitted for proper operation of the circuit. Accordingly, the value −5 indicates a timing violation is present in the U1/D path for Scenario A.

Data for a second path, U2/D through a second cell U2 terminating at a pin “D” indicates a slack value of 2. Accordingly, there is no timing violation associated with this path, since the slack has a positive value. A third path through a third cell U3 terminates at a pin “D” of the third cell. The slack for the U3/D path is −3, indicating a timing violation.

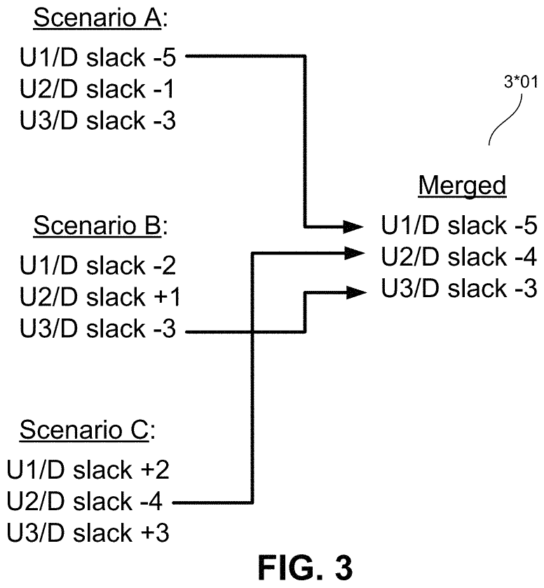

FIG. 3 is a simplified illustration of three STA scenarios (Scenario A, Scenario B and Scenario C) and how the information might be “merged” under ideal conditions (i.e., with unlimited resources available), resulting in a merged scenario 301. Merging is how information from several scenarios is combined in a manner that eliminates unnecessary information (i.e., redundancy or overlap) and maintains valuable information (i.e., the worst case slack for each path in the design taken from all scenarios; in this simplified example, all three scenarios).

In this case it can be seen that the worst case slack of −5 exists in scenario A for the first path U1/D. That is the slack for the first path in scenario B is −2. While this is still a violation, it is not as bad as the slack of −5 for the first path U1/D in scenario A. The slack for the first path in Scenario C is +2. This is not in violation of the rules and so clearly better than the violation that occurs in the first path in Scenario B and in the first path in Scenario A. The worst case scenario for the second path, U2/D is −4 in Scenario C. This is clearly worse than the slack of minus one in the second path in Scenario A and worse than the slack of +1 for the slack of the second path in Scenario B. The slack in third path in scenario B of −3 is the worst from among the three scenarios.

Therefore, the first path of the merged scenario 301 has a of slack of −5, the second path has a of slack of −4 and the third path has a of slack of −3.

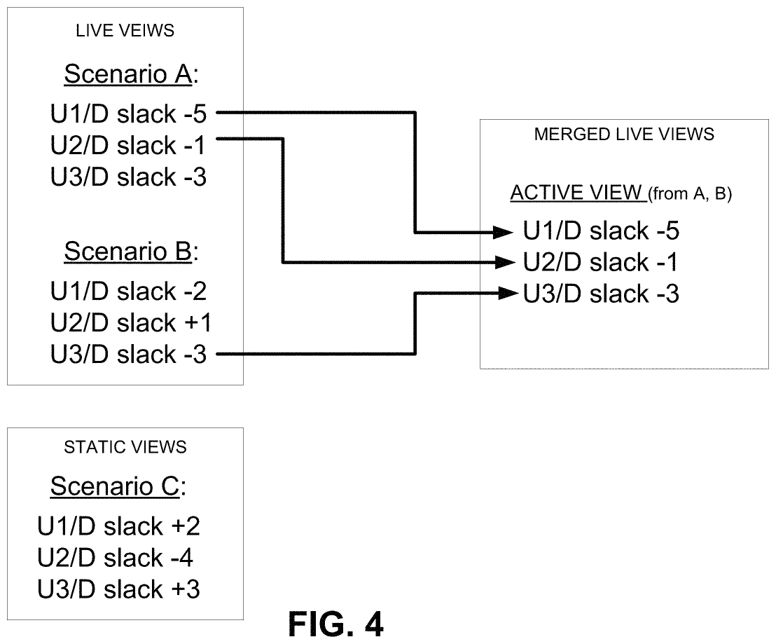

FIG. 4 is a simplified illustration of the use of live views and static views. In conditions in which there is a limit on the amount of processing resource and memory that is desirable to allocate, the use of live views and static views provides a way to reduce the number of scenarios that need to be “active”. That is, only timing of the paths associated with the scenarios selected to be in a live view are active (i.e., updated on the fly as ECO changes are made to correct timing violations). The timing of the paths that are associated with scenarios that are in the static view have a fixed value that is set at the beginning of the process (i.e., before any fixes are implemented to remove timing violations).

As can be seen in FIG. 4, two of the three scenarios are included in the live views and one is included in the static views. In an example embodiment, the determination as to whether to include each scenario in the live view or the static view is made based on the fact that Scenario A has three timing violations and Scenario B has two timing violations, whereas Scenario C has only one timing violation. However, this is a simplification of the way the determination will be made. Such determinations are made by the classifier 103 (see FIG. 1). Nonetheless, the resulting slack values that are present for the live views include only those from Scenario A and Scenario B. In the example shown, the timing violation that is present in the path U2/D in scenario C in which the slack has a value of −4 is not present in the live views.

Once each scenario is determined to be in either the live views 105 or static views 107 (i.e., the classifier 103 places each scenario 101 in either the live view group or the static view group), the live views are merged to form a merged live view. Live views are merged to form merged live views by determining worst cases for each operational feature within a set of live views. In the example shown, the operational feature is the timing slack for a particular path through an IC. For each scenario, the operational status of each feature (i.e., the value for the timing slack for each particular path) is determined under the conditions associated with that scenario. The worst case timing slack for each path is selected from the set of live scenarios and forms the operational status of that path (i.e., that operational feature) for the merged live view.

Timing information is “transferred” from the static views to the merged live view so that timing violations and other ECO data across all scenarios are contained in live views, allowing subsequent ECO operations to be performed on all violations Timing violations in the scenarios that are held in the static views need to be fixed, even if the timing violations are not covered in the live views. This allows all violations to be fixed while preventing any ping pong effect between the live and the static views. Violations in the static views (not available in live views) can be fixed by transferring the timing violations and other necessary information to the live view and artificially creating the same timing and violations in live views that were present in the static views.

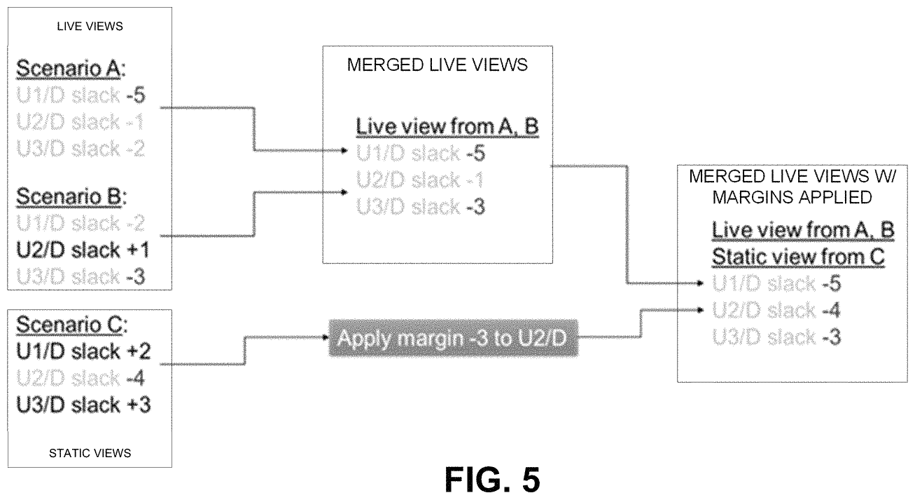

FIG. 5 is an illustration of how the timing violation for the path U2/D in Scenario C (and other such timing violation that might occur in scenarios that are not in the live views) is transferred to take all the timing violations in the static views into consideration. A determination is made to calculate the difference in the slack in the path of each scenario in the static views that indicates a timing violation and the slack in the same path of the merged live views (i.e., a “margin” is calculated).

In the case of the example shown in FIG. 5, the path U2/D of Scenario C has a slack of −4, indicating a timing violation in the U2/D path. The slack for the merged live view path U2/D has a value of −1. While this slack also indicates a timing violation in the U2/D path under the conditions imposed for Scenario A, the timing of the U2/D path for Scenario A is “better” than the timing for the same path (i.e., U2/D) under the conditions of Scenario C. Therefore, in order to account for the fact that the timing of path U2/D is worse in Scenario C than in the merged live views, the margin is calculated. That is, the difference between the slack value of −1 for the U2/D path in Scenario A and the slack value of −4 for the U2/D path in the Scenario C is determined to be −4 minus −1 equals −3. This margin is then applied to the slack of the live view path U2/D, resulting in a slack value of −4 for the path U2/D in the merged live views. In this way, when fixes are implemented for the timing violations, the timing violation that is present in the path U2/D under the conditions of Scenario C will be taken into account, even though Scenario C is not in the live views.

In some embodiments, prior to signing off the IC design as ready for “tape-out”, the timing for each path is checked for a set of Scenarios that provides assurances that the IC design will operate as required in all conditions over which the IC is likely to be subjected.

In an example design in which there are two hundred scenarios, after analyzing the timing information from all two hundred scenarios, the classifier 103 divides the scenarios 101 into those that are placed into the live view group and those that are placed into the static view group. In some embodiments, the determination is based on timing criticality, the number of timing violations, parasitic corners, timing constraints, etc.

In some embodiments, critical timing scenarios and dominant timing scenarios are included in the live views to provide accurate timing during the ECO stage. Less critical timing scenarios and non-dominant scenarios are analyzed in static views which are not updated during the ECO stage, since the timing of the circuit for the scenarios of the static views may not need to be updated during this stage. Rather, the calculated margin for each path in which there is a timing violation in one of the Scenarios is used to adjust the slack associated with that path in the merged live views.

In some embodiments, the classifier 103 uses classification algorithms based on current given input data. In other embodiments, the classifier also uses Machine Learning (ML) techniques to take advantage of previous knowledge and data accumulated by other designs and prior projects.

The disclosed approach compares to the traditional approach for a design with 148 scenarios as follows. Each scenario takes about 14 GB memory and 4 cores for ECO operation in the traditional approach. In one embodiment in which the disclosed approach uses 20 live views with 128 static views, a 7× memory reduction and 30× core reduction in hardware resources results, while maintaining almost identical setup and hold timing fix rates.

The above examples show how timing violations were transferred from static views to live views, but this technique is not limited to timing violations. Rather, it can be applied to other electrical characteristic modeling: such as timing, noise, power, temperature, and voltage. Accordingly, any operational scenario (e.g., timing scenarios) can be identified with at least one operational condition (e.g., temperature or voltage) and divided into static and live views. A determination is then made regarding the operational status of the operational features (e.g., whether there are timing violations in the signal paths) under the conditions associated with the scenarios (e.g., when operating at the particular voltage, temperature and other operational conditions associated with each particular scenario). Margins can then be determined and associated with each of the operational features (such as signal paths) within at least one scenario of a static view. Information can then be transferred from at least one of the scenarios of the static view to a merged live view through the application of the margin to an associated operational feature of the merged live view.

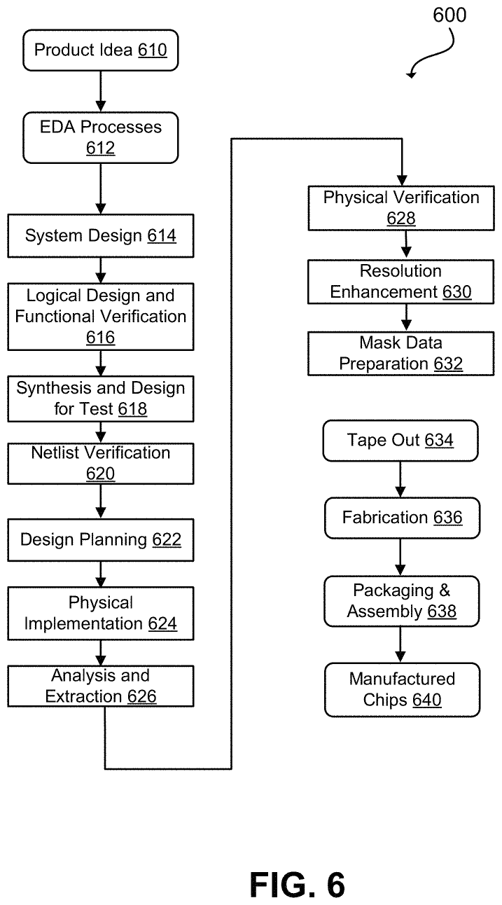

FIG. 6 illustrates an example set of processes 600 used during the design, verification, and fabrication of an article of manufacture, such as an IC, to transform and verify design data and instructions that represent the IC. Each of these processes can be structured and enabled as multiple modules or operations. These processes start with a product idea 610. Information regarding the product idea is supplied by a designer. The information is used to form a plan for the fabrication of an article of manufacture. This is done using a set of EDA processes 612. ‘EDA’ is an acronym for ‘Electronic Design Automation’. Once finalized, the design is taped-out 634. Tape-out is when an artwork for the IC (e.g., geometric patterns representing structures of the design of the IC) is sent to a fabrication facility to manufacture a mask set. The mask set is then used to manufacture the IC. After tape-out, a semiconductor die is fabricated 636. Packaging and assembly processes 738 are then performed to produce the finished IC 640.

Specifications for a circuit or electronic structure may range from low-level transistor material layouts to high-level description languages. A high-level of abstraction may be used to design circuits and systems, using a hardware description language (‘HDL’) such as VHDL, Verilog, SystemVerilog, SystemC, MyHDL or OpenVera. The HDL description can be transformed to a logic-level register transfer level (‘RTL’) description, a gate-level description, a layout-level description, or a mask-level description. Each lower abstraction level that is a less abstract description adds more useful detail into the design description, for example, more details for the modules that include the description. The lower levels of abstraction that are less abstract descriptions can be generated by a computer, derived from a design library, or created by another design automation process. An example of a specification language at a lower level of abstraction language for specifying more detailed descriptions is SPICE, which is used for detailed descriptions of circuits with many analog components. Descriptions at each level of abstraction are enabled for use by the corresponding tools of that layer (e.g., a formal verification tool). The processes described may be enabled by EDA products (or tools).

During system design 614, the functionality of an IC to be manufactured is specified. The design may be optimized for desired characteristics; such as power consumption, performance, area (physical and/or lines of code), and cost efficiency, etc. Partitioning of the design into different types of modules or components may occur at this stage.

During logic design and functional verification 616, modules or components in the circuit are specified in one or more description languages and the specification is checked for functional accuracy. For example, the components of the circuit may be verified to generate outputs that match the requirements of the specification of the circuit or system being designed. Functional verification may use simulators and other programs such as testbench generators, static HDL checkers, and formal verifiers. In some embodiments, special systems of components referred to as ‘emulators’ or ‘prototyping systems’ are used to speed up the functional verification.

During synthesis and design for test 618, HDL code is transformed to a netlist. In some embodiments, a netlist may be a graph structure where edges of the graph structure represent components of a circuit and where the nodes of the graph structure represent how the components are interconnected. Both the HDL code and the netlist are hierarchical articles of manufacture that can be used by an EDA product to verify that the IC, when manufactured, performs according to the specified design. The netlist can be optimized for a target semiconductor manufacturing technology. Additionally, the finished IC may be tested to verify that the IC satisfies the requirements of the specification.

During netlist verification 620, the netlist is checked for compliance with timing constraints and for correspondence with the HDL code. During design planning 622, an overall floor plan for the IC is constructed and analyzed for timing and top-level routing.

During layout or physical implementation 624, physical placement (positioning of circuit components such as transistors or capacitors) and routing (connection of the circuit components by multiple conductors) occurs, and the selection of cells from a library to enable specific logic functions can be performed. As used herein, the term ‘cell’ may specify a set of transistors, other components, and interconnections that provides a Boolean logic function (e.g., AND, OR, NOT, XOR) or a storage function (such as a flipflop or latch). As used herein, a circuit ‘block’ may refer to two or more cells. Both a cell and a circuit block can be referred to as a module or component and are enabled as both physical structures and in simulations. Parameters are specified for selected cells (based on ‘standard cells’) such as size and made accessible in a database for use by EDA products.

During analysis and extraction 626, the circuit function is verified at the layout level, which permits refinement of the layout design. During physical verification 628, the layout design is checked to ensure that manufacturing constraints are correct, such as DRC constraints, electrical constraints, lithographic constraints, and that circuitry function matches the HDL design specification. During resolution enhancement 730, the geometry of the layout is transformed to improve how the circuit design is manufactured.

During tape-out, data is created to be used (after lithographic enhancements are applied if appropriate) for production of lithography masks. During mask data preparation 732, the ‘tape-out’ data is used to produce lithography masks that are used to produce finished ICs.

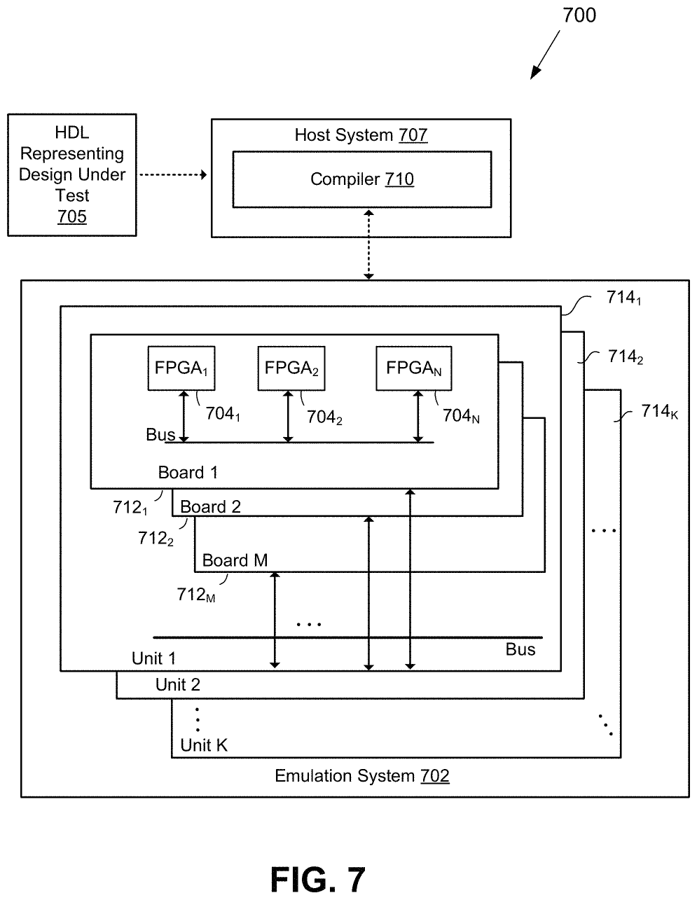

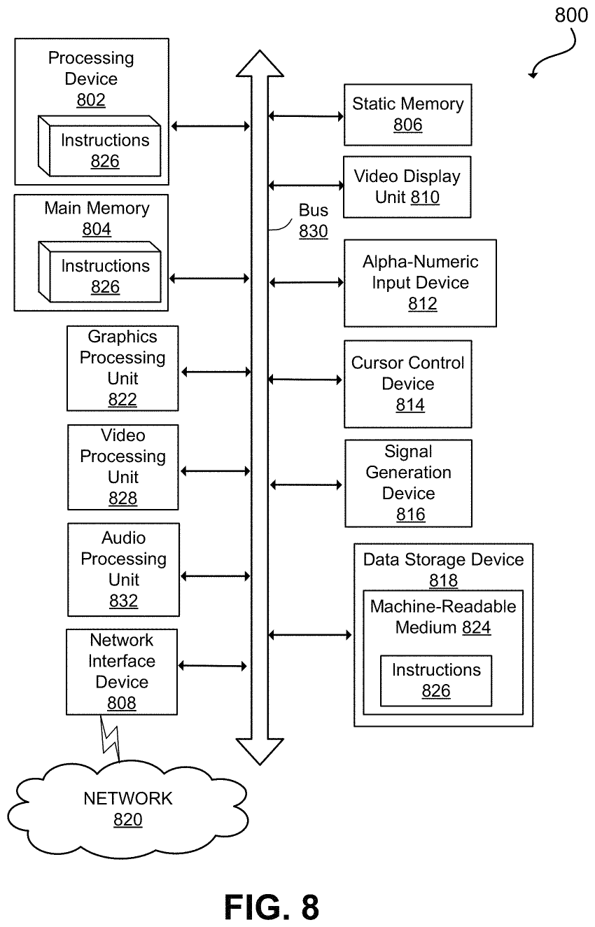

A storage subsystem of a computer system (such as computer system 800 of FIG. 8, or host system 707 of FIG. 7) may be used to store the programs and data structures that are used by some or all of the EDA products described herein, and products used for development of cells for the library and for physical and logical design that use the library.

FIG. 7 depicts an abstract diagram of an example emulation environment 700. An emulation environment 700 may be configured to verify the functionality of the circuit design. The emulation environment 700 may include a host system 707 (e.g., a computer that is part of an EDA system) and an emulation system 702 (e.g., a set of programmable devices such as Field Programmable Gate Arrays (FPGAs) or processors). The host system generates data and information by using a compiler 710 to structure the emulation system to emulate a circuit design. A circuit design to be emulated is also referred to as a Design Under Test (‘DUT’) where data and information from the emulation are used to verify the functionality of the DUT.

The host system 707 may include one or more processors. In the embodiment where the host system includes multiple processors, the functions described herein as being performed by the host system can be distributed among the multiple processors. The host system 707 may include a compiler 710 to transform specifications written in a description language that represents a DUT and to produce data (e.g., binary data) and information that is used to structure the emulation system 702 to emulate the DUT. The compiler 710 can transform, change, restructure, add new functions to, and/or control the timing of the DUT.

The host system 707 and emulation system 702 exchange data and information using signals carried by an emulation connection. The connection can be, but is not limited to, one or more electrical cables such as cables with pin structures compatible with the Recommended Standard 232 (RS232) or universal serial bus (USB) protocols. The connection can be a wired communication medium or network such as a local area network or a wide area network such as the Internet. The connection can be a wireless communication medium or a network with one or more points of access using a wireless protocol such as BLUETOOTH or IEEE 702.11. The host system 707 and emulation system 702 can exchange data and information through a third device such as a network server.

The emulation system 702 includes multiple FPGAs (or other modules) such as FPGAs 704₁ and 704₂ as well as additional FPGAs to 704_{N}. Each FPGA can include one or more FPGA interfaces through which the FPGA is connected to other FPGAs (and potentially other emulation components) for the FPGAs to exchange signals. An FPGA interface can be referred to as an input/output pin or an FPGA pad. While an emulator may include FPGAs, embodiments of emulators can include other types of logic blocks instead of, or along with, the FPGAs for emulating DUTs. For example, the emulation system 702 can include custom FPGAs, specialized ASICs for emulation or prototyping, memories, and input/output devices.

A programmable device can include an array of programmable logic blocks and a hierarchy of interconnections that can enable the programmable logic blocks to be interconnected according to the descriptions in the HDL code. Each of the programmable logic blocks can enable complex combinational functions or enable logic gates such as AND, and XOR logic blocks. In some embodiments, the logic blocks also can include memory elements/devices, which can be simple latches, flip-flops, or other blocks of memory. Depending on the length of the interconnections between different logic blocks, signals can arrive at input terminals of the logic blocks at different times and thus may be temporarily stored in the memory elements/devices.

FPGAs 704₁-704_{N} may be placed onto one or more boards 712₁ and 712₂ as well as additional boards through 712_{M}. Multiple boards can be placed into an emulation unit 714₁. The boards within an emulation unit can be connected using the backplane of the emulation unit or any other types of connections. In addition, multiple emulation units (e.g., 714₁ and 714₂ through 714_{K}) can be connected to each other by cables or any other means to form a multi-emulation unit system.

For a DUT that is to be emulated, the host system 300 transmits one or more bit files to the emulation system 702. The bit files may specify a description of the DUT and may further specify partitions of the DUT created by the host system 707 with trace and injection logic, mappings of the partitions to the FPGAs of the emulator, and design constraints. Using the bit files, the emulator structures the FPGAs to perform the functions of the DUT. In some embodiments, one or more FPGAs of the emulators may have the trace and injection logic built into the silicon of the FPGA. In such an embodiment, the FPGAs may not be structured by the host system to emulate trace and injection logic.

The host system 707 receives a description of a DUT that is to be emulated. In some embodiments, the DUT description is in a description language (e.g., a register transfer language (RTL)). In some embodiments, the DUT description is in netlist level files or a mix of netlist level files and HDL files. If part of the DUT description or the entire DUT description is in an HDL, then the host system can synthesize the DUT description to create a gate level netlist using the DUT description. A host system can use the netlist of the DUT to partition the DUT into multiple partitions where one or more of the partitions include trace and injection logic. The trace and injection logic traces interface signals that are exchanged via the interfaces of an FPGA. Additionally, the trace and injection logic can inject traced interface signals into the logic of the FPGA. The host system maps each partition to an FPGA of the emulator. In some embodiments, the trace and injection logic is included in select partitions for a group of FPGAs. The trace and injection logic can be built into one or more of the FPGAs of an emulator. The host system can synthesize multiplexers to be mapped into the FPGAs. The multiplexers can be used by the trace and injection logic to inject interface signals into the DUT logic.

The host system creates bit files describing each partition of the DUT and the mapping of the partitions to the FPGAs. For partitions in which trace and injection logic are included, the bit files also describe the logic that is included. The bit files can include place and route information and design constraints. The host system stores the bit files and information describing which FPGAs are to emulate each component of the DUT (e.g., to which FPGAs each component is mapped).

Upon request, the host system transmits the bit files to the emulator. The host system signals the emulator to start the emulation of the DUT. During emulation of the DUT or at the end of the emulation, the host system receives emulation results from the emulator through the emulation connection. Emulation results are data and information generated by the emulator during the emulation of the DUT which include interface signals and states of interface signals that have been traced by the trace and injection logic of each FPGA. The host system can store the emulation results and/or transmits the emulation results to another processing system.

After emulation of the DUT, a circuit designer can request to debug a component of the DUT. If such a request is made, the circuit designer can specify a time period of the emulation to debug. The host system identifies which FPGAs are emulating the component using the stored information. The host system retrieves stored interface signals associated with the time period and traced by the trace and injection logic of each identified FPGA. The host system signals the emulator to re-emulate the identified FPGAs. The host system transmits the retrieved interface signals to the emulator to re-emulate the component for the specified time period. The trace and injection logic of each identified FPGA injects its respective interface signals received from the host system into the logic of the DUT mapped to the FPGA. In case of multiple re-emulations of an FPGA, merging the results produces a full debug view.

The host system receives, from the emulation system, signals traced by logic of the identified FPGAs during the re-emulation of the component. The host system stores the signals received from the emulator. The signals traced during the re-emulation can have a higher sampling rate than the sampling rate during the initial emulation. For example, in the initial emulation a traced signal can include a saved state of the component every X milliseconds. However, in the re-emulation the traced signal can include a saved state every Y milliseconds where Y is less than X. If the circuit designer requests to view a waveform of a signal traced during the re-emulation, the host system can retrieve the stored signal and display a plot of the signal. For example, the host system can generate a waveform of the signal. Afterwards, the circuit designer can request to re-emulate the same component for a different time period or to re-emulate another component.

A host system 707 and/or the compiler 710 may include sub-systems such as, but not limited to, a design synthesizer sub-system, a mapping sub-system, a run time sub-system, a results sub-system, a debug sub-system, a waveform sub-system, and a storage sub-system. The sub-systems can be structured and enabled as individual or multiple modules or two or more may be structured as a module. Together these sub-systems structure the emulator and monitor the emulation results.

The design synthesizer sub-system transforms the HDL that is representing a DUT 705 into gate level logic. For a DUT that is to be emulated, the design synthesizer sub-system receives a description of the DUT. If the description of the DUT is fully or partially in HDL (e.g., RTL or other level of abstraction), the design synthesizer sub-system synthesizes the HDL of the DUT to create a gate-level netlist with a description of the DUT in terms of gate level logic.

The mapping sub-system partitions DUTs and maps the partitions into emulator FPGAs. The mapping sub-system partitions a DUT at the gate level into a number of partitions using the netlist of the DUT. For each partition, the mapping sub-system retrieves a gate level description of the trace and injection logic and adds the logic to the partition. As described above, the trace and injection logic included in a partition is used to trace signals exchanged via the interfaces of an FPGA to which the partition is mapped (trace interface signals). The trace and injection logic can be added to the DUT prior to the partitioning. For example, the trace and injection logic can be added by the design synthesizer sub-system prior to or after the synthesizing the HDL of the DUT.

In addition to including the trace and injection logic, the mapping sub-system can include additional tracing logic in a partition to trace the states of certain DUT components that are not traced by the trace and injection. The mapping sub-system can include the additional tracing logic in the DUT prior to the partitioning or in partitions after the partitioning. The design synthesizer sub-system can include the additional tracing logic in an HDL description of the DUT prior to synthesizing the HDL description.

The mapping sub-system maps each partition of the DUT to an FPGA of the emulator. For partitioning and mapping, the mapping sub-system uses design rules, design constraints (e.g., timing or logic constraints), and information about the emulator. For components of the DUT, the mapping sub-system stores information in the storage sub-system describing which FPGAs are to emulate each component.

Using the partitioning and the mapping, the mapping sub-system generates one or more bit files that describe the created partitions and the mapping of logic to each FPGA of the emulator. The bit files can include additional information such as constraints of the DUT and routing information of connections between FPGAs and connections within each FPGA. The mapping sub-system can generate a bit file for each partition of the DUT and can store the bit file in the storage sub-system. Upon request from a circuit designer, the mapping sub-system transmits the bit files to the emulator, and the emulator can use the bit files to structure the FPGAs to emulate the DUT.

If the emulator includes specialized ASICs that include the trace and injection logic, the mapping sub-system can generate a specific structure that connects the specialized ASICs to the DUT. In some embodiments, the mapping sub-system can save the information of the traced/injected signal and where the information is stored on the specialized ASIC.

The run time sub-system controls emulations performed by the emulator. The run time sub-system can cause the emulator to start or stop executing an emulation. Additionally, the run time sub-system can provide input signals and data to the emulator. The input signals can be provided directly to the emulator through the connection or indirectly through other input signal devices. For example, the host system can control an input signal device to provide the input signals to the emulator. The input signal device can be, for example, a test board (directly or through cables), signal generator, another emulator, or another host system.

The results sub-system processes emulation results generated by the emulator. During emulation and/or after completing the emulation, the results sub-system receives emulation results from the emulator generated during the emulation. The emulation results include signals traced during the emulation. Specifically, the emulation results include interface signals traced by the trace and injection logic emulated by each FPGA and can include signals traced by additional logic included in the DUT. Each traced signal can span multiple cycles of the emulation. A traced signal includes multiple states and each state is associated with a time of the emulation. The results sub-system stores the traced signals in the storage sub-system. For each stored signal, the results sub-system can store information indicating which FPGA generated the traced signal.

The debug sub-system allows circuit designers to debug DUT components. After the emulator has emulated a DUT and the results sub-system has received the interface signals traced by the trace and injection logic during the emulation, a circuit designer can request to debug a component of the DUT by re-emulating the component for a specific time period. In a request to debug a component, the circuit designer identifies the component and indicates a time period of the emulation to debug. The circuit designer's request can include a sampling rate that indicates how often states of debugged components should be saved by logic that traces signals.

The debug sub-system identifies one or more FPGAs of the emulator that are emulating the component using the information stored by the mapping sub-system in the storage sub-system. For each identified FPGA, the debug sub-system retrieves, from the storage sub-system, interface signals traced by the trace and injection logic of the FPGA during the time period indicated by the circuit designer. For example, the debug sub-system retrieves states traced by the trace and injection logic that are associated with the time period.

The debug sub-system transmits the retrieved interface signals to the emulator. The debug sub-system instructs the debug sub-system to use the identified FPGAs and for the trace and injection logic of each identified FPGA to inject its respective traced signals into logic of the FPGA to re-emulate the component for the requested time period. The debug sub-system can further transmit the sampling rate provided by the circuit designer to the emulator so that the tracing logic traces states at the proper intervals.

To debug the component, the emulator can use the FPGAs to which the component has been mapped. Additionally, the re-emulation of the component can be performed at any point specified by the circuit designer.

For an identified FPGA, the debug sub-system can transmit instructions to the emulator to load multiple emulator FPGAs with the same configuration of the identified FPGA. The debug sub-system additionally signals the emulator to use the multiple FPGAs in parallel. Each FPGA from the multiple FPGAs is used with a different time window of the interface signals to generate a larger time window in a shorter amount of time. For example, the identified FPGA can require an hour or more to use a certain amount of cycles. However, if multiple FPGAs have the same data and structure of the identified FPGA and each of these FPGAs runs a subset of the cycles, the emulator can require a few minutes for the FPGAs to collectively use all the cycles.

A circuit designer can identify a hierarchy or a list of DUT signals to re-emulate. To enable this, the debug sub-system determines the FPGA needed to emulate the hierarchy or list of signals, retrieves the necessary interface signals, and transmits the retrieved interface signals to the emulator for re-emulation. Thus, a circuit designer can identify any element (e.g., component, device, or signal) of the DUT to debug/re-emulate.

The waveform sub-system generates waveforms using the traced signals. If a circuit designer requests to view a waveform of a signal traced during an emulation run, the host system retrieves the signal from the storage sub-system. The waveform sub-system displays a plot of the signal. For one or more signals, when the signals are received from the emulator, the waveform sub-system can automatically generate the plots of the signals.

FIG. 8 illustrates an example machine of a computer system 800 in which a set of instructions may be executed to cause the machine to perform one or more methodologies discussed herein. In alternative implementations, the machine may be connected (e.g., networked) to other machines in a LAN, an intranet, an extranet, and/or the Internet. The machine may operate in the capacity of a server or a client machine in client-server network environment, as a peer machine in a peer-to-peer (or distributed) network environment, or as a server or a client machine in a cloud computing infrastructure or environment.

The machine may be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 800 includes a processing device 802, a main memory 804 (e.g., read-only memory (ROM), flash memory, dynamic random access memory (DRAM) such as synchronous DRAM (SDRAM), a static memory 806 (e.g., flash memory, static random access memory (SRAM), etc.), and a data storage device 818, which communicate with each other via a bus 830.

Processing device 802 represents one or more processors such as a microprocessor, a central processing unit, or the like. More particularly, the processing device may be complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 802 may also be one or more special-purpose processing devices such as an application specific integrated circuit (ASIC), a field programmable gate array (FPGA), a digital signal processor (DSP), network processor, or the like. The processing device 802 may be configured to execute instructions 826 for performing the operations and steps described herein.

The computer system 800 may further include a network interface device 808 to communicate over the network 820. The computer system 800 also may include a video display unit 810 (e.g., a liquid crystal display (LCD) or a cathode ray tube (CRT)), an alphanumeric input device 812 (e.g., a keyboard), a cursor control device 814 (e.g., a mouse), a graphics processing unit 822, a signal generation device 816 (e.g., a speaker), graphics processing unit 822, video processing unit 828, and audio processing unit 832.

The data storage device 818 may include a machine-readable storage medium 824 (also known as a non-transitory computer-readable medium) on which is stored one or more sets of instructions 826 or software embodying any one or more of the methodologies or functions described herein. The instructions 826 may also reside, completely or at least partially, within the main memory 804 and/or within the processing device 802 during execution thereof by the computer system 800, the main memory 804 and the processing device 802 also constituting machine-readable storage media.

In some implementations, the instructions 826 include instructions to implement functionality corresponding to the present disclosure. While the machine-readable storage medium 824 is shown in an example implementation to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instructions for execution by the machine and that cause the machine and the processing device 802 to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm may be a sequence of operations leading to a desired result. The operations are those requiring physical manipulations of physical quantities. Such quantities may take the form of electrical or magnetic signals capable of being stored, combined, compared, and otherwise manipulated. Such signals may be referred to as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the present disclosure, it is appreciated that throughout the description, certain terms refer to the action and processes of a computer system, or similar electronic computing device, that manipulates and transforms data represented as physical (electronic) quantities within the computer system's registers and memories into other data similarly represented as physical quantities within the computer system memories or registers or other such information storage devices.

The present disclosure also relates to an apparatus for performing the operations herein. This apparatus may be specially constructed for the intended purposes, or it may include a computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various other systems may be used with programs in accordance with the teachings herein, or it may prove convenient to construct a more specialized apparatus to perform the method. In addition, the present disclosure is not described with reference to any particular programming language. It will be appreciated that a variety of programming languages may be used to implement the teachings of the disclosure as described herein.

The present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form readable by a machine (e.g., a computer). For example, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

In the foregoing disclosure, implementations of the disclosure have been described with reference to specific example implementations thereof. It will be evident that various modifications may be made thereto without departing from the broader spirit and scope of implementations of the disclosure as set forth in the following claims. Where the disclosure refers to some elements in the singular tense, more than one element can be depicted in the figures and like elements are labeled with like numerals. The disclosure and drawings are, accordingly, to be regarded in an illustrative sense rather than a restrictive sense.

What is claimed is:

1. A method comprising:
identifying a plurality of operational scenarios, each operational scenario associated with a set of conditions;
determining operational status for at least one operational feature under the sets of conditions associated with the plurality of scenarios;
dividing operational scenarios into live and static views;
determining margins associated with operational features within at least one scenario of a static view; and
transferring information from the at least one scenario of a static view to a merged live view through the margin.

2. The method of claim 1, wherein the at least one condition comprises operational conditions.

3. The method of claim 2, wherein the operational conditions comprise at least temperature conditions.

4. The method of claim 1, wherein the at least one condition comprises process conditions.

5. The method of claim 4, wherein the process conditions comprises process variations.

6. The method of claim 1, wherein the at least one operational feature comprises timing of signals over paths of an integrated circuit.

7. The method of claim 6, wherein the timing of signals over paths of an integrated circuit comprises timing slack.

8. The method of claim 1, wherein dividing operational scenarios into live and static views comprises determining which scenarios are updated on the fly and which are not updated as fixes are made.

9. The method of claim 1, wherein differences between the operational features of the static and live views are used to determine margins.

10. The method of claim 8, wherein a set of live view scenarios are merged to form merged live views by determining worst cases for each operational feature within the set of live views.

11. A system comprising:
a memory storing instructions; and
a processor, coupled with the memory and to execute the instructions, the instructions when executed cause the processor to:
identify a plurality of operational scenarios, each associated with a unique set of conditions;
determine operational status for a plurality of operational features under the sets of conditions associated with the plurality of scenarios;
divide operational scenarios into live and static views;
determine margins associated with operational features within at least one scenario of a static view; and
transfer information from the at least one scenario of a static view to a merged live view through the margin.

12. The system of claim 11, wherein the at least one condition comprises operational conditions.

13. The system of claim 12, wherein the operational conditions comprise at least temperature conditions.

14. The system of claim 11, wherein the at least one condition comprises process conditions.

15. The system of claim 14, wherein the process conditions comprises process variations.

16. The system of claim 11, wherein, the at least one operational feature comprises timing of signals over paths of an integrated circuit.

17. The system of claim 16, wherein the timing of signals over paths of an integrated circuit comprises timing slack.

18. The system of claim 11, wherein dividing operational scenarios into live and static views comprises determining which scenarios are updated on the fly and which are not updated as fixes are made.

19. The system of claim 11, wherein differences between the operational features of the static and live views are used to determine margins.

20. The system of claim 19, wherein, a set of live view scenarios are merged to form merged live views by determining worst cases for each operational feature within the set of live views.

21. A non-transitory computer readable medium comprising stored instructions, which when executed by a processor, cause the processor to:
identify a plurality of operational scenarios with at least one operational condition;
determine operational status for a plurality of operational features under the conditions associated with the plurality of scenarios;
divide operational scenarios into live and static views;
determine margins associated with operational features within at least one scenario of a static view; and
transfer information from the at least one scenario of a static view to a merged live view through the margin.
